(19) United States
(12) Patent Application Publication
(10) Pub. No.: US 2005/0084127 A1
(43) Pub. Date: Apr. 21, 2005

(54) Audio loudspeaker enclosure

(76) Inventor: John M. Norton, Tujunga, CA (US)

Correspondence Address: John F. Letchford;Klehr, Harrison, Harvey, Branzburg & Ellers LLP, 260 South Broad Street, Philadelphia, PA, 19102, US

(21) Appl. No.: 10/943,829

(22) Filed: Sep. 16, 2004

Related U.S. Application Data
(60) Provisional application No. 60/504,262, filed on Sep. 18, 2003.

(51) Int. Cl. H04R 1/02; H04R 1/20

(52) U.S. Cl. 381/338; 381/346; 381/354

(57) ABSTRACT

The invention describes the incorporation of surface irregularities into a loudspeaker enclosure to control the resonances of enclosure. Through the use of the described resonance control techniques, a single loudspeaker driver housed by the enclosure is able to offer excellent performance over a wide range of the audio spectrum. The randomness of the selected features is constrained within a set of boundary conditions to accomplish a balance of achieving the desired performance, as well as ensure that the device is practical to manufacture.

### CROSS-REFERENCE TO RELATED APPLICATION

This application claims the benefit of U.S. Provisional Application No. 60/504,262, filed Sep. 18, 2003, entitled “Boundary Constrained Randomness for Loudspeaker Enclosures.”

### FIELD OF THE INVENTION

The present invention relates in general to audio loudspeakers and in particular to a loudspeaker enclosure that enables a single speaker driver to offer excellent performance over a wide range of the audio spectrum. In the present context, the terms “loudspeaker” and “speaker” are synonymous and are used interchangeably herein.

### BACKGROUND OF THE INVENTION

A cross-sectional view of a typical loudspeaker driver is shown in FIG. 1, with the sound emitting diaphragm and other basic components of the speaker noted therein. Typically, the diaphragm is round in shape, but other shapes such as ovals and squares have been used. The diaphragm is usually not flat, but has a certain amount of depth from the inner edge to the outer edge. When employed for a loudspeaker diaphragm, this depth results in three-dimensional shapes such as a cones and domes having smooth radiating surfaces and edges.

Traditionally, multi-way speaker systems have several speaker drivers of varying sizes to facilitate reproduction of the full range of audible frequencies. As used herein, the term “multi-way” shall be construed to mean a speaker system that employs a first speaker for emitting sound at low frequencies (e.g., a woofer) and at least one additional speaker for emitting sound at comparatively higher frequencies. Larger speaker drivers are used to reproduce low frequencies, with progressively smaller drivers used to reproduce progressively higher frequencies. The various speaker drivers are connected to an electrical signal that is frequency limited to accommodate the specific capabilities of each speaker driver. As described below, frequency limiting is performed with electrical components either at the output of the driving amplifier, or at the input to a number of amplifiers.

There are two primary interconnection topologies in use for multi-way speaker systems. A typical circuit diagram of the “passive crossover” type, shown in FIG. 2, accomplishes frequency limiting for each device driver through direct connection to the output of an amplifier, with electrical components dividing up the full audible frequency range into frequency bands that are suited to each driver. The “active crossover” type, a typical circuit diagram of which is shown in FIG. 3, performs frequency dividing before the input to the amplifier associated with each loudspeaker component, so that the loudspeaker component can be connected directly to its dedicated amplifier output.

Due to frequency-dependent phase shift inherent in both of types of crossover designs, there is degradation in the audio signal being received by each of the speaker components covering the selected audible range. This phase shift is further aggravated by the physical displacement of each of the multi-way speaker components in the speaker enclosure with respect to one another (which displacement, in turn, is limited by mounting constraints within the speaker enclosure). For passively crossed over speaker systems, there are additional degradations in signal quality since the crossover components must divide up full range amplifier signals ranging from several watts to many hundreds of watts. A resultant degradation is the loss of power absorbed in the crossover, often referred to “insertion loss.” Further distorting the signal delivered to the speaker is the intrinsic variation of the loss with varying power levels.

Where active crossovers are employed, some of the passive crossover deficiencies are resolved. Nevertheless, the imperfections of phase distortion and overlapping frequency response remain, although factors such as signal level variations on the crossover element are reduced. However, this topology does require a separate amplifier and cabling for each loudspeaker driver, and that has a significant increase on the cost and the potential reduction of reliability for this sound system topology.

In addition to electronics-related audio performance deficiencies, currently available multi-way speaker systems suffer from acoustic problems created by the shapes of their enclosures. The following is a discussion of the inherent acoustic disadvantages caused by the interior and exterior shapes of existing loudspeaker enclosures.

Internal Properties

The vast majority of existing speaker systems have rectangular box-shaped enclosures. An example of a conventional multiple-way speaker with a rectangular box enclosure is shown in FIG. 4. The enclosures are typically constructed of wood or a wood composite, although occasionally other materials such as plastic are used. The popularity of the rectangular shape is likely due to its ease of design and manufacture, but this shape inherently has a detrimental effect on the sound quality of the speaker drivers housed within.

Limitations of the rectangular box shaped include standing waves that develop between the parallel surfaces inside of the enclosure. For each set of parallel surfaces, there are resonances that develop at frequencies that correspond to the wavelengths of the physical dimensions. The effect of box resonances has been applied in applications unrelated to speaker systems. These structures are referred to as Helmholz resonators. In general, however, these inherent resonances are undesirable in the performance of a loudspeaker system, as they lead to variations in sound output level over the frequencies that are dimensionally proportionate to cabinet geometries.

Certain speaker enclosure designs attempt to address this particular limitation by fabricating the speaker enclosure with a number of non-parallel sides to reduce the severity of standing waves within the enclosure. Typically the sides representing the largest surface area are chosen be designed to be non-parallel. FIG. 5 depicts a “slant-sided” example of this type of design. The parallel surfaces that remain in such a design will nonetheless still exhibit the detrimental frequency response characteristics described above. The slanted or curved surfaces will ameliorate the frequency irregularities over the frequency ranges dimensionally proportionate to the wavelengths of these surfaces. However, the enclosure will still exhibit resonant coloration, spread over the frequencies with wavelengths corresponding to the range of dimensions of the slanted or curved surfaces.

Other methods are also employed to reduce inner-enclosure standing waves, such as internal cross members and the use of a variety of sound absorption materials. These methods have a degree of success, depending on the materials used for the enclosure, but ultimately are only partially effective in masking the inherent standing waves in a box shaped speaker enclosure.

Recently, more exotic designs have been introduced to address standing wave issues. These designs typically use spherically-based geometries to overcome the standing waves inherent in box designs. However, because of the symmetry that exists in two dimensions for spherically-based enclosures, there still exists another type of resonance, which is dimensionally proportionate to the wavelength of the diameter of the enclosure. For an example of this type of resonance, consider the familiar resonance that is exhibited by the tap of a wine glass. Apart from its opening—which corresponds to where a speaker would be mounted in a spherical speaker enclosure—the receptacle portion of a wine glass is essentially spherical in shape. The design of a similarly shaped speaker enclosure could be fabricated to reduce these resonant tendencies, but this tonal signature is still inherent in the spherical shape.

At the very high end of existing speaker enclosure design, the spherical shape is elongated in one axis, as illustrated in FIG. 6. This design would reduce the fundamental resonant frequency due to the lack of symmetry in two dimensions. However, the shape will still resonate at a range of frequencies, at wavelengths proportionate to the dimensions of the physical geometry. Again, as an analogy, consider the resonances exhibited by the tap of a log-stemmed glass whose receptacle portion has similar symmetric dimensionality. In such a situation, the fundamental frequency will be reduced, but it will be replaced by a range of resonant frequencies.

External Properties

In addition to internally generated resonances, there are a host of detrimental effects that result from the external geometries of existing speaker enclosure topologies.

Referring again to the rectangular box type enclosures described earlier, there are several undesirable influences that occur with this geometry. The primary source in most conventional box designs is acoustic diffraction from the edges of the rectangular enclosure. Essentially, the sharper the corners of the rectangular shape, the greater the effects of edge diffraction. This phenomena has been described as a second sound wave being generated from the large pressure drop as the acoustic wave reaches the edge of the cabinet.

Many high end speaker enclosure manufacturers have rounded the edges of their rectangular shaped speaker enclosure to reduce the effect of edge diffraction on overall frequency response. When existing products have employed this technique, the radius of this rounded edge has been held constant. A correlation has been proven to exist between the radius of the edge of an enclosure and the wavelength of a specific frequency. The sharper the edge of the enclosure, the more secondary frequencies or overtones are produced. These secondary frequencies color or distort the sounds being reproduced by the speaker.

In the case of multi-way speaker systems, which use a plurality of decreasingly sized speaker drivers to reproduce the frequencies of decreasing wavelengths, there is a secondary effect. The individual drivers themselves introduce various degrees of boundary effects as the acoustic waves from each interact with physical dimensions of adjacent drivers, each generating independent subsets of boundary effects over specific sets of frequency ranges. The boundary effects that each driver presents to each of its neighboring drivers are similar in effect to the pressure drop associated with edge diffraction.

Multi-way speaker systems must make a tradeoff between physical isolation of each multi-way speaker element, with desirability of keeping each driver as close together as possible to insure the best imaging and transient response. The inherent need for physical displacement the drivers to isolate, the inter-driver acoustic boundary effect is essentially at odds with the desirability of grouping the assortment of varying frequency drivers to preserve cohesiveness of the source signal.

Notwithstanding available methodologies for dampening speaker enclosure distortion presented by the prior art, a multi-way speaker system nonetheless requires multiple speaker diaphragms of differing sizes, multiple drivers, multiple speaker suspension parts, and either multiple amplifiers or multiple electronic filtering means in order to service the full range of the audio spectrum. The result is that conventional speaker systems are complex in design and expensive to manufacture.

An advantage exists, therefore, for a loudspeaker system that employs a resonance reducing speaker enclosure that enables a single speaker driver to effectively radiate audio signals across the audible spectrum. So equipped, such a system would require only one amplifier and a single set of speaker suspension parts, thereby resulting in a loudspeaker of simple and compact design and comparatively lesser manufacturing cost than conventional multi-way speakers. In addition, phase-related and other distortions that affect conventional multi-way speakers would be ameliorated.

### SUMMARY OF THE INVENTION

The present invention eliminates the need for a plurality a speakers of various sized components to cover the full audio range. Through the use of a novel design approach, a single loudspeaker is capable of accommodating essentially the entire audible frequency spectrum (about 20 Hz to about 20 kHz).

The present invention uses boundary constrained randomized geometry to reduce the resonances outlined above that are inherent in existing speaker enclosures. In particular, the present invention relies on surface irregularities intentionally incorporated into a speaker's enclosure in order to achieve wide-range frequency performance from a single loudspeaker. In other words, in contrast to traditional speaker design methodologies in which plurality of drivers are arrayed in a speaker enclosure, the present invention exploits previously unexpected performance advantages arising from structural imperfections intentionally introduced into a speaker enclosure whereby a single driver may be use to effectively reproduce the audible spectrum.

The present invention seeks to anticipate the series of nodal resonances inherent in conventional speaker enclosures, and provide design elements that allow smooth transition between the various nodal orders while simultaneously diffusing the magnitude of each nodal order. According to the invention, the key to diffusing the series of nodal resonant series inherent in conventional loudspeaker enclosures is to introduce resonance reducing structural features into a speaker enclosure that are, preferably, random in nature and impart surface irregularities to either or both of the interior and exterior surfaces of the enclosure.

According to a preferred embodiment, three-dimensional structural features such as projections and/or depressions formed in relief with respect to either or both of the interior and exterior surfaces of a speaker enclosure. Such structural features are preferably irregularly shaped and may assume the form of ribs, stalks or veins or other three-dimensional shapes. Additional benefits flowing from the use of structural features configured as ribs, stalks or veins is that they are easily formed in the enclosure fabrication process and add dimensional stiffness to the enclosure. Other arbitrary shapes may also be used so long as they also randomize and therefore mitigate the resonances which are intrinsic conventional loudspeaker enclosure designs.

A speaker enclosure that uses the resonance mitigation schemes described herein results in a loudspeaker system that preferably employs a single speaker to effectively radiate audio signals across the audible spectrum and one that is compact and less expensive to manufacture than conventional multi-way speaker systems.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a cross-sectional view of a conventional cone-type loudspeaker;

FIG. 2 is a circuit diagram of a passive crossover employed in a conventional multi-way speaker system;

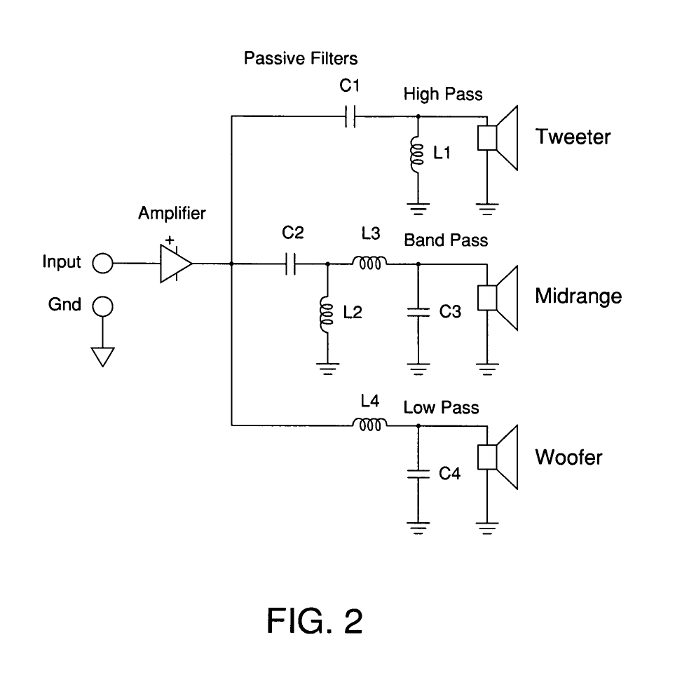

FIG. 3 is a circuit diagram of an active crossover employed in a conventional multi-way speaker system;

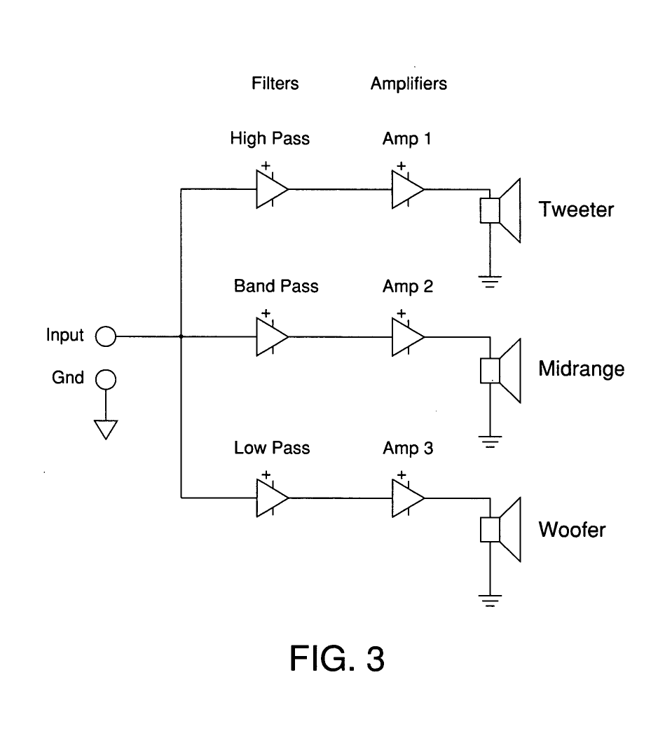

FIG. 4 is a perspective view of a multi-way speaker system with a rectangular box enclosure;

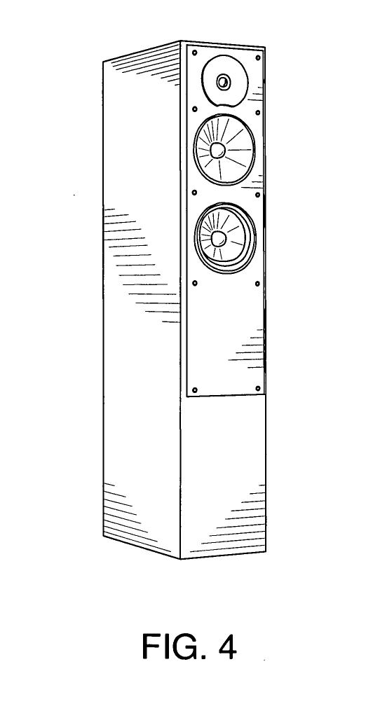

FIG. 5 is a perspective view of a multi-way speaker system with a slant sided box enclosure;

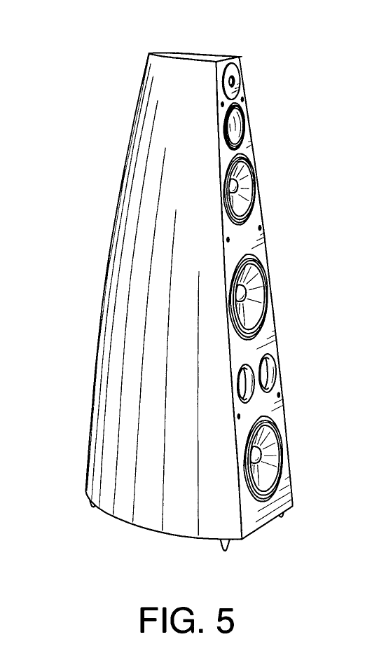

FIG. 6 is a perspective view of an alternative to conventional box-type speaker enclosures for multi-way speaker systems;

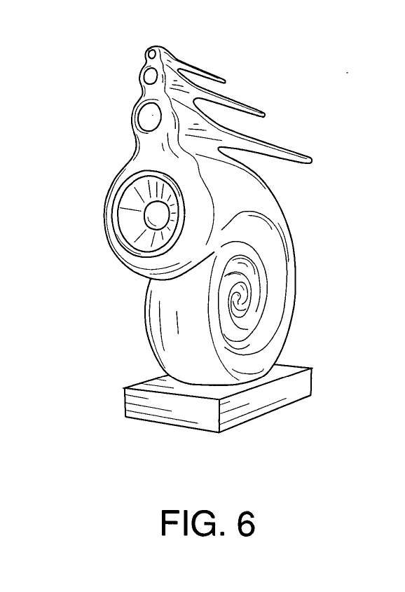

FIG. 7 is an internal view of a speaker enclosure constructed according to the present invention;

FIG. 8 is a perspective view of a speaker enclosure constructed according to the present invention;

FIG. 9 is a front perspective view of a shelf-supported loudspeaker constructed according to the present invention;

FIG. 10 is a rear perspective view of the loudspeaker shown in FIG. 9; and

FIG. 11 is a front perspective view of a floor-supported loudspeaker constructed according to the present invention.

### DETAILED DESCRIPTION OF THE INVENTION

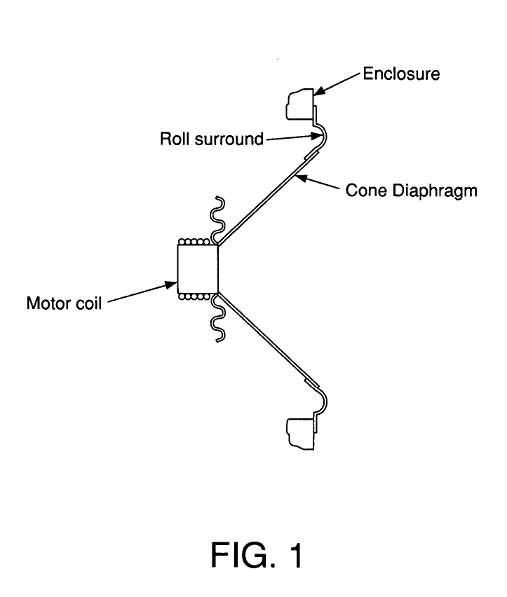

The present invention describes the use of a conventional dynamic motor as the excitation force on the diaphragm similar to that shown in FIG. 1. Such a motor is comprised of a voice coil wound on a voice coil former, held in a strong magnetic field by the use of a “spider” support and the diaphragm roll surround. This type of electro-dynamic speaker is by far the most prevalent type in use today. However, the design principles described herein for resonance control are also applicable to other electro-motive techniques such as those employed by electrostatic speakers.

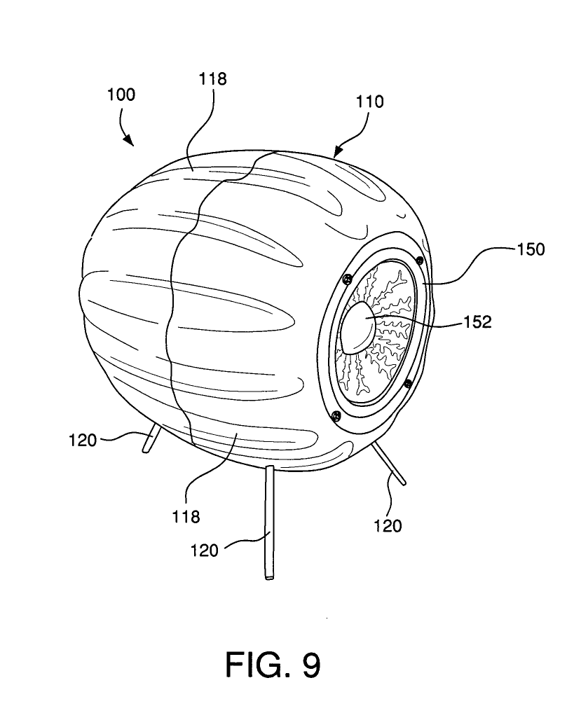

To address the issue of interior standing waves, the present invention employs a random series of radii to define the interior dimensions, as viewed from the centerline of a mounted loudspeaker driver such as those shown in FIGS. 9-11. To achieve the necessary interior volumetric requirements and manufacturing practicality, the randomness of the radii is constrained within predefined limits.

In addition to varying the radii of the interior surface with respect to the centerline of a mounted loudspeaker driver, consideration is also given to the geometric center of the interior of the enclosure. Again, the values of the radii from this point to interior surface of the enclosure are also preferably randomized within pre-described boundaries. In this manner, the present invention not only eliminates any parallel surfaces, but also eliminates any symmetry which could cause undesirable resonance or coloration from sound emanated from the rear of the loudspeaker driver.

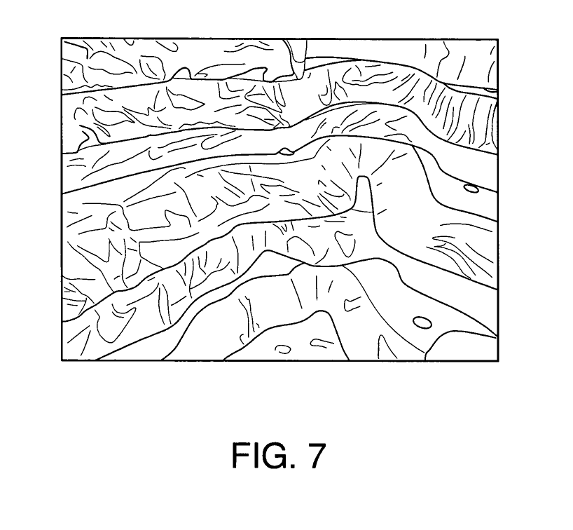

Since a loudspeaker driver is potentially capable of producing a wide range of frequencies, a design consideration of the present invention concerns the dimensionality of the randomness of the aforementioned radii, as viewed from a given point. To fully realize the benefits of boundary constrained randomness, the granularity of the randomness must also be considered with regard to the wavelengths of the frequencies associated with a given loudspeaker driver. Viewed another way, the randomness of the dimensions extends not only from the macro level, which defines the gross interior volume of the enclosure, but also to a much finer level that extends to increasingly finer texture of the interior space. FIG. 7 is an example of an interior of a speaker enclosure that utilizes the boundary constrained randomness concepts of the present invention.

As illustrated in FIG. 7, the surface is preferably formed such that straight edges, parallel surfaces, sphericities and other geometrical symmetries that would serve as generators of undesirable resonances are avoided. In other words, the interior surface of the speaker is preferably a randomized, entirely irregular surface. The material in which the irregular surface is formed may be the same as or different from that of the exterior of the enclosure. Suitable materials into which the irregular interior surface may be formed or machined include wood or plastics or any other materials used in the manufacture of speaker enclosures. Lightweight materials such as foamed polystyrene (Styrofoam), cork and the like are also acceptable.

Thus far the reader's attention has been directed to improving the resonance reducing characteristics of interior space of a loudspeaker enclosure, whose primary purpose is absorb the rearward energy generated by the speaker driver. However, the same principles are also relevant, to a similar extent, to the exterior shape and texture of the exterior of the enclosure of the present invention.

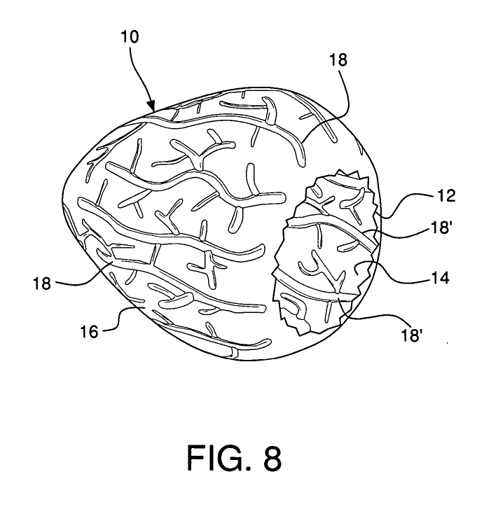

Referring to FIG. 8, there is shown an embodiment of a loudspeaker enclosure constructed in accordance with the present invention (with the speaker driver thereof omitted for clarity of illustration). The enclosure, identified generally by reference numeral 10, has a speaker driver opening 12 an interior surface 14 and an exterior surface 16. Although illustrated as circular for accommodating the most commonly shaped speaker driver, opening 12 may assume the peripheral shape of any presently known or hereinafter developed symmetrical, asymmetrical, geometric or randomly shaped driver.

Regardless of whether they are circular, elliptical, rectangular or some other shape, the edges of speaker driver openings of conventional loudspeaker enclosures are smooth or regular. However, their very smoothness results in unwanted acoustic edge diffractions when the speaker driver is operating. Accordingly, in addition to an irregular interior surface (and an irregular outer surface, as discussed below), it is also preferred that enclosure 10 have a speaker driver opening 12 that has an irregular or somewhat jagged edge. In other words, the periphery of opening 12 is preferably defined by a continuum of randomly changing radii with respect to the center of the opening. By making the opening's edge irregular in shape edge diffraction is effectively eliminated. In contrast with traditional designs, such a varying radius around the driver opening reduces the pressure drop at any given frequency from the enclosure side where the speaker driver is mounted. The randomness of the opening radii also ensures that one frequency is not optimally diffused more than any others. The total effect of the randomized edge of opening 12 surrounding the speaker driver is to spread the decoupling of edge diffraction over a wide range of frequencies being emanated by the speaker driver.

Once past the initial radius surrounding the speaker driver opening 12, the present invention proposes the continued randomized geometry in exterior surface 16 in order to further decouple acoustic diffraction as the sound waves propagate along the outer surface of the enclosure. Since loudspeakers are typically required to reproduce a wide range of frequencies, the granularity of the randomness in exterior surface 16 is also scaled in accordance with the present invention to suit the varying wavelengths that are produced by the speaker driver.

As shown in FIG. 8, enclosure 10 is preferably constructed as an irregularly shaped object. Indeed, exterior surface 16, the interior surface 14, is preferably devoid of straight edges, parallel surfaces, sphericities and other geometrical symmetries that would serve as generators of harmful resonances. Pursuant to the invention, the exterior surface 16 is provided with surface irregularities in the form of three-dimensional structural features 18. The three-dimensional structural features may assume the form of projections and/or depressions formed in relief with respect to the exterior surface. The height and/or depth of structural features 18 is constrained to an elevation suitable for effective manufacture of enclosure 10. Structural features 18 are preferably irregular in shape and randomly arranged and may assume any three-dimensional shape or shapes for achieving the objects of the present invention.

In the illustrative but non-limitative example shown in FIG. 8, three-dimensional structural features 18 are constructed as a plurality of formations resembling ribs, stalks or veins that extend from the speaker driver opening 12. It is also preferable that they interleave with other such structural features. In addition to the relatively simple three-dimensional structural features 18 shown in FIG. 8, there are essentially unlimited structural variations that may accomplish very specific levels of resonance control to compensate for inadequacies in the materials used in fabrication, specific adaptations to physical design constraints and the preferences of target groups of end users of the speaker.

FIG. 8 reveals how an enclosure with random surface irregularities 18 might appear if the enclosure were fabricated from molded plastic including, without limitation, epoxy resin reinforced with carbon fiber. If molded from plastic, it would be especially easy to provide additional or corresponding three-dimensional structural features 18′ in the interior surface 14 of the enclosure.

The present inventor has observed that structural randomness is highly relevant to eliminating resonant frequencies in the interior and exterior surfaces of a speaker enclosure. Ideally, all surfaces between the three-dimensional surface structures 18 are asymmetrical in shape in order to reduce the tendency towards resonance. However, given the tendency of all surfaces towards resonance, the use of varied sizes and shapes of the sub-regions between structures 18, as dictated by the shapes of the structures, effectively eliminates a dominant resonance frequency for a loudspeaker enclosure on a macro level.

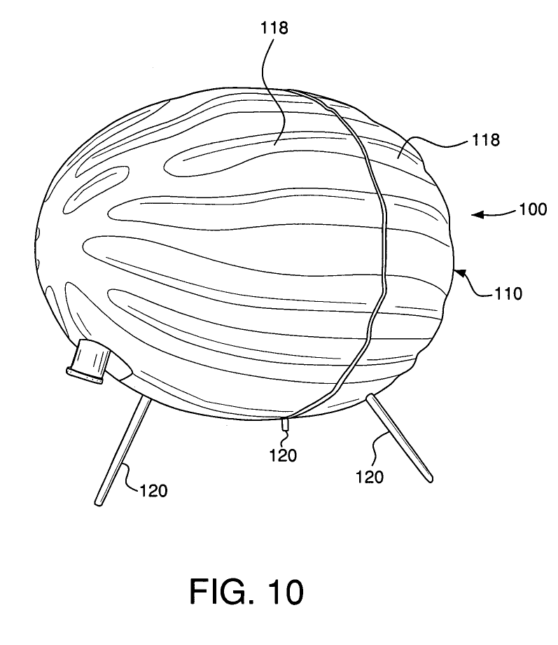

FIGS. 9 and 10 illustrate a shelf-supported loudspeaker constructed according to the present invention. The loudspeaker, identified generally by reference numeral 100, includes enclosure 110 and a speaker driver 150 (FIG. 9) mounted therein. As depicted, driver 150 is a cone-type driver whose diaphragm is also desirably provided with resonance reducing surface irregularities 152 such as three-dimensional structures provided on the inner and/or outer surface of the radiating face of the diaphragm, an irregular edge where the diaphragm is joined to the roll surround, and/or perforations in the radiating surface. Speaker 100 be supported by a relatively low-height detachably or permanently connected stand or pedestal or, as illustrated, three or more legs 120.

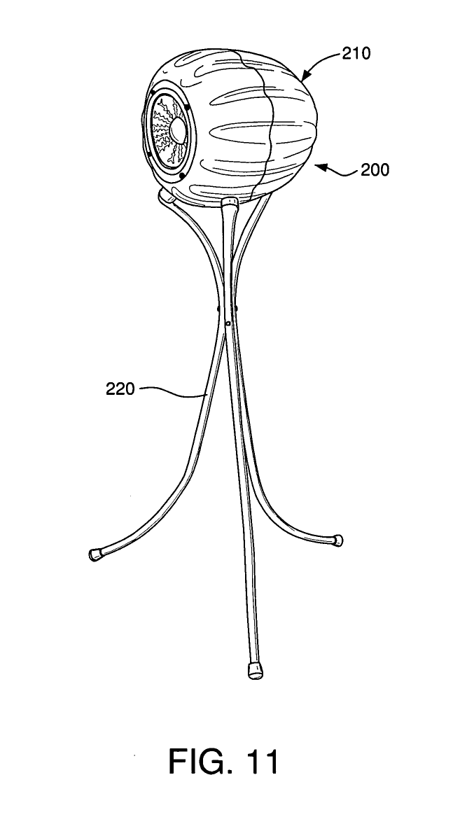

Loudspeaker 200 shown in FIG. 11 corresponds in every material respect loudspeaker 100 of FIGS. 9 and 10, except that it is supported by a comparatively tall pedestal or stand 220 whereby it functions as a free-standing floor-supported speaker assembly.

The present invention enhances conventional speaker enclosure geometry and thereby disrupt the formation of resonant nodes. It does this via three-dimensional structural features which produce randomized geometries into shape and surfaces of the enclosure. The resultant advantages are manifold:
Reduced and diffused intrinsic nodal resonances endemic in the enclosure to enable a speaker driver to provide usable response over a wide spectrum of audible frequencies.
Enhanced rigidity of the speaker enclosure, which is useful when the speaker driver is in the low frequency “piston” mode of operation.
Enhancements are constrained to practical levels of material draw (the flow characteristics of plastics during the diaphragm molding process), improved reliability or other attribute of consideration in the manufacture or end use of the product.

In addition, the aesthetic characteristics of the resonance reducing three-dimensional structural features 18 are virtually infinite. That is, essentially any conceivable form of randomized indicia can be used to create resonance reducing surface irregularities on speaker enclosures according to the present invention. For instance, the three-dimensional structural features 18 can employ a variety of “seed patterns” to accomplish desired design objectives. By way of illustration but not limitation, the seed pattern can be a corporate logo such as the familiar Nike, Inc. “swoosh” logo or whimsical patterns such as flowers, fractals, geometric shapes such as honeycombs, or images such as Japanese Kanji characters.

A loudspeaker according to the preferred embodiment of the invention, i.e., a single driver speaker, has significant advantages over the traditional multi-way loudspeaker systems. By eliminating a crossover system and its attendant phase shift, frequency response overlap and insertion (power loss), the instant invention represents a substantial improvement in the efficacy of a loudspeaker system. Additionally, by using a single driver, the preferred embodiment avoids physical separation of an array of differently sized drivers in a single loudspeaker enclosure that produces a components layout which is audible at typical user listening distances. For instance, a listener can hear a woofer operating separately from a tweeter in the same speaker enclosure. The advantages of a single driver capable of a wide frequency range are manifest when musical transients, common in music from sources such as vocal, stringed and, in particular, percussive instruments, are considered. Given the mathematical composition of even a brief transient signal, the harmonic series compromises a frequency range into the infinite. Even if a multi-way speaker system were capable of the necessary range, it is not possible for the listener's ear to be able to re-construct accurate transient information from an array of transducers physically displaced from one another in a manner consistent with currently available multi-way speaker systems.

Furthermore, speakers constructed in accordance with the present invention are small in size and therefore can be housed in correspondingly small enclosures. As a result, a very compact single-driver speaker system is achieved that is useful in virtually any room setting while avoiding the bulk, weight, and aesthetic disadvantages of multi-way speaker systems.

While use with a single speaker driver is preferred, the enclosure according to the present invention may be used, if desired, with a plurality of speaker drivers to cover separate ranges of the audible frequency spectrum. In this instance, several varying sized enclosures would need to be employed to house the required set of speaker drivers necessary to accomplish reproduction of the entire audible frequency range. Typically, the range of speakers would be of a variety of physical sizes, requiring enclosures of appropriate sizes to house each of the individual drivers. With the reduced acoustic diffraction offered by present invention, such a multi-speaker system would commensurately reduce the effect of boundary effects each driver presents to surrounding loudspeaker drivers. However, as with any loudspeaker system employing a range of speaker drivers for reproduction of segments of the audio spectrum, the use of passive or active electronic crossover networks would necessarily be employed to segregate the overall frequency response to suit the specific frequency ranges of the individual speaker drivers employed. And, even with the highest quality electronic components, the use of these frequency dividing crossover networks introduce phase shift, distortion and/or insertion loss to the full range signal being presented to the loudspeaker system.

Although the invention has been described in detail for the purpose of illustration, it is to be understood that such detail is solely for that purpose and that variations can be made therein by those skilled in the art without departing from the spirit and scope of the invention as claimed herein.

1. An audio loudspeaker enclosure comprising:
an interior surface;
an exterior surface;
an opening for receiving a speaker driver; and
resonance reducing surface irregularities provided on at least one of said interior surface, said exterior surface and an edge of said opening.

2. The enclosure of claim 1 wherein said resonance reducing surface irregularities are randomly arranged on said at least one of said interior surface, said exterior surface and an edge of said opening.

3. The enclosure of claim 1 wherein said resonance reducing surface irregularities comprise three-dimensional structural features provided on at least one of said interior surface and said exterior surface.

4. The enclosure of claim 3 wherein said three-dimensional structural features comprise at least one of projections and depressions formed in relief with respect to said at least one of said interior surface and said exterior surface.

5. The enclosure of claim 3 wherein said three-dimensional structural features are randomly arranged on said at least one of said interior surface and said exterior surface.

6. The enclosure of claim 1 wherein said resonance reducing surface irregularities comprise an irregular edge provided along an edge of said opening.

7. An audio loudspeaker comprising the enclosure of claim 1.
